(19) United States
(12) Patent Application Publication
(10) Pub. No.: US 2024/0066505 A1
(43) Pub. Date: Feb. 29, 2024

(54) NOBLE METAL SINGLE ATOM SUPPORTED THREE-WAY CATALYST AND PREPARATION METHOD THEREFOR AND USE THEREOF

(71) Applicant: BEIJING SINGLE ATOM SITE CATALYSIS TECHNOLOGY CO., LTD, BEIJING (CN)

(72) Inventors: Yang LI, BEIJING (CN); Chao LIAN, BEIJING (CN); Hongchen YANG, BEIJING (CN); Mingliang DENG, BEIJING (CN); Mengyun WANG, BEIJING (CN); Minduo WANG, BEIJING (CN)

(21) Appl. No.: 18/260,073

(22) PCT Filed: Dec. 20, 2021
(86) PCT No.: PCT/CN2021/139730

§ 371 Date: Jun. 30, 2023

(30) Foreign Application Priority Data
Dec. 31, 2020 (CN) 202011637233.4

(51) Int. Cl. B01J 23/63; B01D 53/94; B01J 35/00; B01J 37/04; B01J 37/06; B01J 37/08

(52) U.S. Cl. CPC B01J 23/63; B01D 53/945; B01J 35/006; B01J 37/04; B01J 37/06; B01J 37/08; B01D 2258/01

(57) ABSTRACT

The present invention relates to a preparation method for a noble metal single atom three-way catalyst, a catalyst obtained by using the method, and a use of the catalyst for purifying motor vehicle exhaust gas. In the present invention, a nitrogen-containing compound is used for treating a noble metal single atom catalyst precursor, avoiding the agglomeration of noble metal single atoms into nanocrystalline particles. The catalyst obtained by the preparation method of the present invention is resistant to high temperature, is not prone to agglomerate, and is resistant to poisoning, and the amount of usage of noble metals is reduced while the purification efficiency of the catalyst for motor vehicle exhaust gas is effectively improved.

### TECHNICAL FIELD

The present invention belongs to the field of environmental catalysis, and in particular relates to a three-way catalyst for purifying motor vehicle exhaust, preparation method thereof and use thereof.

### BACKGROUND ART

As the number of motor vehicles continues to increase, the emissions of motor vehicle exhaust pollutants including carbon monoxide (CO), unburned hydrocarbons (HC) and nitrogen oxides (NOₓ) are also increasing. These gas pollutants are adsorbed on the surface of smog particles and inhaled into the human body, which will cause serious harm to human health; in addition, nitrogen oxides are also the direct cause of acid rain, which directly endangers the safety of the ecological environment.

At present, the catalytic conversion of gasoline vehicle exhaust pollutants using catalysts is one of the most effective methods for controlling pollutant emissions. By a three-way catalyst (TWC), the pollutants (HC, CO and NOₓ) emitted by motor vehicles will be catalytically converted into harmless gases such as carbon dioxide, nitrogen and water that can be discharged into the environment. In order to control motor vehicle exhaust pollution, the requirements of motor vehicle emission regulations are becoming more and more stringent, the requirements for the limit values of various pollutants are getting lower and lower, and the requirements for the anti-aging performance of three-way catalysts are also constantly improving. Traditional catalysts usually meet the increasingly stringent emission regulations by increasing the amount of noble metals used. However, as the use time increases, the catalytic performance of exhaust gas purifiers continues to decline, making it difficult to meet emission standards. Therefore, improving the utilization efficiency of noble metals and prolonging the service life of catalysts have become hotspots in the research and development of three-way catalysts.

Traditional three-way catalysts generally use noble metal salts loaded on a thermally stable support with a certain specific surface area to form active sites of noble metal nanoparticles with catalytic activity. However, the motor vehicle exhaust three-way catalyst composed of such noble metal nanoparticles has the following insurmountable problems: 1. Only the part of the catalyst active components exposed on the catalyst surface can play a catalytic role, so it is inevitable to increase the amount of noble metals to meet the emission requirements, resulting in difficulty in reducing the cost; 2. The high temperature resistance of the noble metal nanoparticles as active components of catalysts can hardly meet the requirements of use, that is, they are easy to agglomerate, grow up, or even leaching from support under high temperature conditions, resulting in decreased activity or even inactivation, which directly affects the service life of the three-way catalysts; 3. The noble metal nanoparticles as active components of catalysts are easy to be poisoned, especially the use of oil with high sulfur content results in the reduction of catalytic activity, even inactivation under severe cases, which will shorten the service life of the catalysts.

### Contents of the Present Invention

The present invention protects a method for preparing a noble metal single-atomic three-way catalyst, comprising:

Step 1: using a nitrogen-containing compound to treat a noble metal single-atomic catalyst precursor;

Step 2: calcining the catalyst precursor treated with the nitrogen-containing compound to obtain the noble metal single-atomic three-way catalyst.

The nitrogen-containing compound is NH₃, dimethylformamide, urea, C₁₋₂₀ alkane amine, C₂₋₂₀ alkene amine, C₁₋₂₀ alkane diamine, C₁₋₂₀ alkane triamine, C₄₋₂₀ cycloalkane amine, C₄₋₂₀ cycloalkane diamine, C₄₋₂₀ nitrogen-containing heterocycle or C₆₋₂₀ aromatic amine; preferably NH₃, dimethylformamide, urea, C₁₋₆ alkane amine, C₁₋₆ alkane diamine or C₆₋₂₀ aromatic amine; more preferably NH₃, ethylenediamine, triethylamine, n-butylamine or dimethylformamide; optionally, a solution of the nitrogen-containing compound can be used, such as aqueous solution, alcohol solution, in which the alcohol solution is a methanol or ethanol solution. In the implementation of the present invention, an aqueous ammonia with a concentration of 0.5-15 wt % or an aqueous solution of ethylenediamine with a concentration of 0.5-15 wt % is used. It is particularly preferred to use 0.5-5 wt % aqueous ammonia, or 0.5-5 wt % aqueous solution of ethylenediamine. The nitrogen-containing compound can realize the purpose of inhibiting the hydrolysis of the noble metal cation and stabilizing the noble metal single atom.

In the catalyst precursor, the noble metal is dispersed in the state of single-atomic sites on a oxide support. The noble metal is selected from the group consisting of platinum, palladium, rhodium, ruthenium, iridium, osmium, gold and silver, and the noble metal is a single one thereof, or a combination of two thereof, or a combination of more thereof; preferably, the noble metal is platinum, rhodium, palladium, iridium or ruthenium, or a combination thereof. The content of the noble metal is 0.01%-5%, preferably 0.1-2% based on the weight of the catalyst. The oxide support is a catalyst support commonly used in the field of motor vehicle exhaust purification, usually a metal oxide support, including alumina, silica-alumina, ceria-zirconia mixed oxide, or molecular sieve, or mixture of any two or more thereof, and can be doped with BaO, La₂O₃, Y₂O₃ and other components. More preferably, the support component is a mixed oxide of Al₂O₃ and Zr—Ce-M-Oₓ oxide, wherein M is one or more selected from the group consisting of Ba, Sr, La, Y, Pr, Nd, and in the mixed oxide, the content of Al₂O₃ is 15-80 wt %, and the content of Zr—Ce-M-Oₓ is 20-85 wt %.

In step 1, the treatment comprises soaking or washing the catalyst precursor with the nitrogen-containing compound, followed by solid-liquid separation to obtain a catalyst precursor treated with the nitrogen-containing compound.

Before step 2, the catalyst precursor treated with the nitrogen-containing compound can be dried as required; and the drying can be carried out by a conventional drying method, oven baking or hot-air baking;

In step 2, the calcination is carried out at 200-600° C., preferably at 300-500° C.

The inventors have found that during the preparation of the noble metal single-atomic catalyst precursor, the anions contained in the noble metal salt may bring impurity anions to the catalyst, which will easily induce the agglomeration of the noble metal atoms loaded on the oxide support into nanoparticles during the calcination process, so that it is difficult to form (maintain) a catalyst in which the noble metal is in single-atomic dispersion state. Before high-temperature calcination, the treatment with nitrogen-containing compound can significantly decrease the content of impurity anions, and finally the single-atomic state of noble metal is maintained, and the tendency of single atoms to agglomerate into nanoparticles is suppressed.

The present invention seeks to protect a method for preparing a noble metal single-atomic supported three-way catalyst, comprising:
Step A: loading a noble metal precursor in a designed load amount on an oxide support to form a noble metal single-atomic catalyst precursor;
Step B: using a nitrogen-containing compound to treat the noble metal single-atomic catalyst precursor;
Step C: calcining the catalyst precursor treated with the nitrogen-containing compound as obtained in Step B to obtain a noble metal single-atomic three-way catalyst.

The noble metal precursor is soluble noble metal inorganic salt, or noble metal organic salt, or noble metal complex; preferably, it is a nitrate, chloride, sulfate, acetate, acetylacetonate or chlorine complex. The term “soluble” means that it is soluble in water or alcohol, wherein the alcohol is methanol or ethanol.

The noble metal single-atomic three-way catalyst is dispersed in the state of single-atomic sites on the oxide support. Wherein, the noble metal is one or a combination of two or more of platinum, palladium, rhodium, ruthenium, iridium, osmium, gold and silver, preferably the noble metal is platinum, rhodium, palladium or iridium, or a combination of two or more thereof. The content of the noble metal is 0.01%-5%, preferably 0.1-2%, based on the weight of the catalyst. The oxide support is a catalyst support commonly used in the field of motor vehicle exhaust purification, usually a metal oxide support, including alumina, silica-alumina, optionally stabilized zirconia, ceria, titania and optionally stabilized ceria-zirconia mixed oxide or molecular sieve or a mixture of any two or more thereof, which is optionally doped with components such as BaO, La₂O₃, Y₂O₃, etc. More preferably, the support component is a mixed oxide of Al₂O₃ and Zr—Ce-M-Oₓ oxide, wherein M is one or more selected from the group consisting of Ba, Sr, La, Y, Pr, Nd; and in the mixed oxide, the content of Al₂O₃ is 15-80 wt %, and the content of Zr—Ce-M-Oₓ is 20-85 wt %.

In step A, any means known in the art can be used for loading, including impregnation, adsorption, ion exchange, incipient wetness impregnation, precipitation, spray drying and other methods. The present invention preferably uses an impregnation method, in which a suitable mass (or volume) of noble metal salt solution can be prepared according to the adsorption capacity of the support to ensure that the solution mass is 1-50 times the adsorption capacity of the support, preferably the solution mass is 2-30 times, more preferably 4-25 times the adsorption capacity of the support, the support is mixed with the noble metal salt solution and fully stirred, preferably stirred for 2-400 hours, and then the catalyst precursor loaded with noble metal is obtained by separation.

In step B, the treatment comprises soaking or washing the catalyst precursor with the nitrogen-containing compound, followed by solid-liquid separation to obtain a catalyst precursor treated with the nitrogen-containing compound.

The nitrogen-containing compound is NH₃, dimethylformamide, urea, C₁₋₂₀ alkane amine, C₂₋₂₀ alkene amine, C₁₋₂₀ alkane diamine, C₁₋₂₀ alkane triamine, C₄₋₂₀ cycloalkane amine, C₄₋₂₀ cycloalkane diamine, C₄₋₂₀ nitrogen-containing heterocycle, C₆₋₂₀ aromatic amine; preferably NH₃, dimethylformamide, urea, C₁₋₆ alkane amine, C₁₋₆ alkane diamine, C₆₋₂₀ aromatic amine; more preferably NH₃, ethylenediamine, triethylamine, n-butylamine or dimethylformamide. A solution of the nitrogen-containing compound, such as aqueous solution, alcohol solution, can be used, wherein the alcohol solution is a methanol or ethanol solution; it is preferably to use 0.5-15 wt % aqueous ammonia, or 0.5-15 wt % ethylenediamine aqueous solution, particularly preferably to use 0.5-5 wt % ammonia solution or 0.5-5 wt % ethylenediamine aqueous solution.

Before step C, the catalyst precursor treated with the nitrogen-containing compound can be dried as required; the drying can be selected from conventional drying methods, oven baking, hot-air baking, vacuum drying, freeze drying, etc.;

In step C, the calcination is carried out at 200-600° C., preferably at 300-500° C.

Although when the quality of the noble metal salt solution is equal to the adsorption capacity of the support, that is, the equal volume impregnation method is used to load the noble metal salt, the formed catalyst can also achieve the purpose of the present invention, it is still set that the quality of the noble metal solution is 2-30 times, preferably 4-25 times, and most preferably 5-10 times the adsorption capacity of the support. The dispersion of noble metal on the support could be improved by reducing the concentration of the noble metal solution. On the one hand, the density of noble metal ions per unit volume can be lowered when the decreased concentration is used; on the other hand, by utilizing the characteristics of noble metal cations to repel each other, the noble metal can be more effectively dispersed during the repeated adsorption-desorption process, which is more conducive to form a three-way catalyst precursor in which the noble metal is in single-atomic distribution state.

In this precursor, although the noble metal atoms can be effectively dispersed, there will still be more impurity anions around, which will easily induce the conglomeration and agglomeration of noble metal in the subsequent drying and calcination processes, so the nitrogen-containing compound is required to remove the impurity anions.

The present invention further seeks to protect a use of noble metal single-atomic supported catalyst in purification of motor vehicle exhaust, comprising using the above method to prepare a noble metal single-atomic three-way catalyst, and using the catalyst in the purification of motor vehicle exhaust; in which the noble metal is dispersed in the state of single-atomic sites on the oxide support, and the catalyst is used alone or coated on a honeycomb carrier, and the honeycomb carrier is an alloy honeycomb carrier and/or a ceramic honeycomb carrier. The definitions of the noble metal and the oxide support used to support the noble metal are as described above. The coating can be implemented by using any known method, such as spraying, dipping or brushing. In the present invention, the catalyst is firstly made into a slurry, with or without adding a binder, and then the slurry is coated on the honeycomb carrier.

The present invention further seeks to protect a noble metal single-atomic three-way catalyst, which is prepared by the above method, wherein the noble metal is one or a combination of more selected from the group consisting of palladium, rhodium and platinum, and the support component is a mixed oxide of Al₂O₃ and Zr—Ce-M-Oₓ oxide, wherein M is one or more selected from the group consisting of Ba, Sr, La, Y, Pr, Nd; and in the mixed oxide, the content of Al₂O₃ is 15-80 wt %, and the content of Zr—Ce-M-Oₓ is 20-85 wt %, wherein, the noble metal is dispersed in the state of single-atomic sites on the oxide support.

### Definition and Explanation

In the present invention, “dispersion in state of single-atomic site, single-atomic state, single-atomic distribution, single-atom form or separation state at single-atomic level” refers to a state of active metal elements in which metal atoms (ions) are independently separated from each other, the active metal atoms do not form direct connection metal-metal bonds or metal-O-metal bonds, but are dispersed at atomic level or dispersed in state of single-atomic sites. The metals dispersed in the state of single-atomic sites may exist in the atomic state or in the ionic state, and are more likely between the atomic state and the ionic state (i.e., with a bond length between the two kinds of bond lengths). In metal nanocrystals, metal atoms in the same nanocrystal are bonded to each other, and do not belong to the single-atomic state or single-atomic separation state defined in the present invention; for oxide nanocrystals formed by metal and oxygen, although metal atoms are separated by oxygen elements, it is still possible that the internal metals are directly connected to each other, and the above-mentioned metal state metal nanocrystals will be formed after the reduction reaction, which also do not belong to the single-atomic site state or single-atomic separation state defined in the present invention. For the metal in the state of single-atomic sites protected by the present invention, atoms (ions) are theoretically completely independent between each other. However, due to random deviations in the control of preparation and operating conditions for different batches, it is not ruled out that there are a small amount of agglomerated metal species, such as clusters containing several atoms or ions, in the obtained product; it is also not ruled out that part of the metal is in a nanocrystalline state. In other words, in the catalyst of the present invention, the active metal may be dispersed in the state of single-atomic sites, and at the same time, some of the metal atoms may be in a cluster state, and/or part of the metal may be in a nanocrystalline state. And with the change of the external environment, the single-atomic state may change into the cluster and/or nanocrystalline state. The single-atomic state protected by the present application requires a certain proportion of the noble metal single atoms in various existence forms such as noble metal single atoms, noble metal clusters and noble metal nanocrystals in the catalyst, such as higher than 10%, preferably higher than 20%, especially preferably higher than 50%. However, limited by the current technical means, only relatively rough statistical means can be used. For example, a large number of different local areas randomly selected in the catalyst test sample can be analyzed and characterized by aberration-corrected scanning transmission electron microscopy (AC-STEM), and various forms of noble metal can be randomly selected for statistical analysis; or the catalyst sample can be analyzed by extended X-ray absorption fine structure (EXAFS), which can characterize the overall information of the sample, to obtain the ratio of metal-other atom binding signals to metal-metal bonding signals, and to determine the approximate ratio of single-atomic state. It should be pointed out that, in fact, as long as the technology of the present invention is used in the production of a catalyst product with even partial single-atomic state, the product will also show an improvement in performance. Therefore, as long as the product is prepared according to the method of the present invention, the obtained three-way catalyst with single-atomic characteristics should fall within the scope of protection of this application

In the present invention, Zr—Ce-M-Oₓ oxide can be understood as a doped cerium-zirconium oxide, in which besides cerium and zirconium components, other components (preferably rare earth components) are doped as required. In the present invention, the main components of the Zr—Ce-M-Oₓ oxide include ZrO₂ 20-70 wt %, CeO₂ 20-60 wt %, La₂O₃ 0.2-8 wt %, BaO 0-20%, Y₂O₃ 0-7 wt %, Nd₂O₃ 0-7 wt %, Pr₆O₁₁ 0-6 wt %. Oₓ represents coordinated oxygen, and X is determined by the actual metal quantity and valence.

In the present invention, the noble metal salt is loaded on the oxide support. When the solution mass is 1 times the adsorption capacity of the support, and the support is dipped in the solution, the solution of equal volume is adsorbed on the support; when the solution mass exceeds the adsorption capacity of the support, the support is dipped in excess solution, which is called over-volume impregnation. In actual operation, the adsorption capacity of the support is often measured in advance, the ratio of the adsorption capacity to the weight of the support is calculated, and then the amount of solution added is calculated according to the weight ratio of the solution to the support. For example, 1 g of support absorbs 0.5 g solution, and its adsorption ratio is 0.5, so when the weight ratio of solution to support is 1:2, it is equal-volume impregnation; when the weight ratio of solution to support is 10:1, and the solution mass is 20 times the adsorption capacity of the support, it is over-volume adsorption. Due to differences in the adsorption capacity of supports, the amount of impregnation solution used in the examples of the present invention is simply taken as a multiple of the support mass.

The alkane amine means that the alkane has one amine functional group, the alkane diamine means that the alkane has two amine functional groups, and the alkane triamine means that the alkane has three amine functional groups, and the above-mentioned alkane can be replaced by one or more C₁₋₆ alkyl, C₄₋₂₀ cycloalkyl or C₆₋₂₀ aromatic groups, or the C—C bond in the above alkane can be replaced by unsaturated alkene or alkyne to form an unsaturated carbon chain; the aforementioned C₆₋₂₀ aromatic cyclic amine refers to an aromatic cyclic amine compound with 6 to 20 carbon atoms, wherein aromatic group includes aromatic group and heteroaromatic group, the heteroaromatic group means having aromatic 2n+4 characteristics, and at the same time, part of the ring carbon atoms are replaced by heteroatoms, and the heteroatoms are O, N atoms. The C₄₋₂₀ nitrogen-containing heterocycle refers to a nitrogen-containing heterocycle having 4 to 20 ring carbon atoms; the C₄₋₂₀ cycloalkane amine or cycloalkane diamine refers to a group containing 4 to 20 ring carbon atoms and one or two amine functional groups. The above-mentioned cycloalkane, nitrogen-containing heterocycle and aromatic ring are one-membered rings or condensed multi-membered rings, and the rings can be subsequently substituted by C₁₋₆ alkane.

The inert gas should be interpreted as a gas that is inert to the reactants and products in the reaction step, and is generally a commonly used protective gas, including nitrogen N₂, helium He, argon Ar, etc.

Complex is also called complex compound, including complexes formed by noble metals or transition metals and ligands. Common ligands include halogens (fluorine, chlorine, bromine, iodine), nitro, nitroso, cyano, amino, water molecule or organic groups, and common complexes are chlorine complexes, ammonia complexes, cyanide complexes, etc., including chloroplatinic acid, chloroplatinate, and chloroplatinic acid hydrate. See “Handbook of Noble Metal Compounds and Complexes Synthesis (Refined)” (Yu Jianmin, 2009, Chemical Industry Press).

### Beneficial Effect

1. The noble metal single-atomic three-way catalyst formed by the present invention can decrease (30% or more) noble metal loading, but still reach or exceed the effects of the noble metal supported three-way catalyst with nanometer or larger particles and normal load capacity, thereby effectively reducing the use cost of motor vehicle exhaust purification catalyst.

2. The noble metal single-atomic three-way catalyst is resistant to high temperature and is not easy to agglomerate, which effectively improves the service life of the motor vehicle exhaust catalyst and provides a solution for achieving the goal of not-replacing the three-way exhaust catalyst in the whole life of motor vehicle.

3. The noble metal single-atomic three-way catalyst has high anti-poisoning activity and can effectively prolong its service life.

### BRIEF DESCRIPTION OF THE DRAWINGS

FIG. 1 shows the electron micrographs of the catalyst obtained in Example 11; (a) shows the transmission electron microscope (TEM) image; (b) shows the high-resolution transmission electron microscope (HR-TEM) image; (c) shows the aberration-corrected scanning transmission electron microscopy (AC-STEM) image. In the photographs, the bright points are the active metal dispersed at single-atomic level.

FIG. 2 shows the high-resolution transmission electron microscope (HR-TEM) image of Comparative Example 2, in which the bright spots are agglomerated active metal.

FIG. 3 shows the catalytic performances for exhaust gas purification of the catalysts of Example 11 and Comparative Example 1; wherein (a) shows the catalytic activity curve for CO; (b) shows the catalytic activity curve for HC; (c) shows the catalytic activity curve for NO.

### SPECIFIC MODELS FOR CARRYING OUT THE PRESENT INVENTION

### Terms and Explanations Used in the Examples

Concentration of noble metal precursor: Calculated by the metal element mass, for example, Pd at a concentration of 0.02 g/g in aqueous solution means that the content of Pd element is 0.02 grams in per gram of the solution.
Micro-reactor device: Micro-reactor or miniature reaction device.
Micro-reactor exhaust gas: Exhaust gas generated after reaction in a micro-reactor or miniature reaction device.
HC: Alkane, volatile alkane
min: Minutes
wt %: Mass percentage
TEM: Transmission electron microscope
HR-TEM: High-resolution transmission electron microscope
AC-STEM: Aberration-corrected scanning transmission electron microscopy.

### Preparation Example 1. Preparation of Composite Oxide Support

A mixed oxide of Al₂O₃ and Zr—Ce-M-Oₓ oxide was prepared, wherein M was one or more selected from the group consisting of Ba, Sr, La, Y, Pr, and Nd, in which the components of the Zr—Ce-M-Oₓ oxide contained ZrO₂ 20-70 wt %, CeO₂ 15-60 wt %, La₂O₃ 0.2-8 wt %, BaO 0-20%, Y₂O₃ 0-7 wt %, Nd₂O₃ 0-7 wt %, and Pr₆O₁₁ 0-6 wt %.

La—Al₂O₃(Al₂O₃ could also be selected), cerium-zirconium solid solution and additive were weighed respectively according to the weight ratio, the raw materials were mixed with water, added with a pH regulator, mixed (stirred or ball milled), and subjected to solid-liquid separation to obtain a composite oxide support. Therein, the additive was selected from the group consisting of barium salt and strontium salt; such as one or a mixture of several of barium acetate, barium sulfate, barium carbonate, barium nitrate, strontium nitrate, strontium carbonate and strontium acetate. La—Al₂O₃ was lanthanum-doped alumina, in which lanthanum content was 1%-10%; cerium-zirconium solid solution was a rare earth oxide mainly containing CeO₂ and ZrO₂, and the cerium-zirconium solid solution contained the following components: ZrO₂ 20-70 wt %, CeO₂ 15-60 wt %, La₂O₃ 0.2-8 wt %, Y₂O₃ 0-7 wt %, Nd₂O₃ 0-7 wt %, and Pr₆O₁₁ 0-6 wt %.

In the present invention, three kinds of composite oxide supports were prepared, which were respectively:
Cerium-zirconium alumina support A, hereinafter referred to as support A, its main components and composition were: Al₂O₃ 31 wt %, ZrO₂ 29 wt %, CeO₂ 16 wt %, BaO 15 wt %, La₂O₃ 3.57 wt %, and Y₂O₃ 1.27 wt %.
Cerium-zirconium alumina support B, hereinafter referred to as support B, its main components and composition were: Al₂O₃42 wt %, ZrO₂ 36 wt %, CeO₂ 9 wt %, Y₂O₃ 8 wt %, and La₂O₃ 5 wt %.
Cerium zirconium alumina support C, hereinafter referred to as support C, its main components and composition were: Al₂O₃64 wt %, ZrO₂ 22 wt %, CeO₂ 8 wt %, Y₂O₃ 2.4 wt %, and La₂O₃ 0.8 wt %.

### Preparation Example 2: Test Method for Exhaust Gas Purification

Reaction device: Micro-reactor (customized, manufactured by Beijing Shiao Technology Co., Ltd.)

Analysis device: Flue gas analyzer (HOR1BA, model MEXA-584L)

Detection method: Pure gases were mixed to simulate the components of motor vehicle exhaust. The simulated motor vehicle exhaust components were: 1.6 wt % CO, 7.67 wt % CO₂, 0.23 wt % H₂, 500 ppm HC (C₃H₈/C₃H₆=2/1), 1000 ppm NO, 1.0 wt % O₂, 10 wt % H₂O (the amount of water could be adjusted according to the needs), N₂ gas was used as balance gas. Before using the device, the water injection speed was adjusted, and the 6 gas channels for CO, NO, HC, CO₂, O₂, and H₂ were calibrated respectively. After calibration, a flow meter was used to measure and adjust the N₂ flow to reach a total flow of 1000 mL/min. 200 mg of 40-60 mesh-sieved catalyst was mixed with 1 g of quartz sand evenly, loaded into the reaction tube and then placed in the heating furnace of the micro-reactor. The detection process comprised: 1. The micro-reactor exhaust gas was introduced into the flue gas analyzer, temperature-programmed and subjected to performance detection: the micro-reactor device was turned on for automatic programmed heating, and the flue gas analyzer with the computer software was turned on for automatic sampling. The temperature range was 100-400° C., the heating rate was 10° C./min, and the temperature was stabilized for 20 minutes at each 20° C. interval. Real-time continuous online sampling was performed at a sampling interval of 1 minute. 2. At the end of the detection, the gas data (provided by the flue gas analyzer) and temperature (provided by the micro-reactor) corresponding to each sampling time point in the heating stage were obtained, which were used to make a temperature-conversion rate data diagram for performance analysis.

### Example 1: Catalyst of 0.66 wt % Palladium Supported on Alumina (201008f)

Aqueous solution of Pd with a concentration of 0.02 g/g was prepared with palladium nitrate solution in advance, 3.96 g of the aqueous solution was taken and diluted with water to 120 g, then added with 11.9 g of support Al₂O₃ and stirred overnight to make palladium fully adsorbed on the surface of the support, centrifuged for solid-liquid separation, and the solid matter was dried overnight at 120° C., taken out and cooled, subjected to soaking in 2 wt % diluted aqueous ammonia overnight, and centrifuged again, and the solid matter was dried at 120° C. overnight, then calcinated at 400° C. for 1 hour to obtain an exhaust purification catalyst of palladium supported on Al₂O₃.

### Example 2: Catalyst of 1.32 wt % Palladium Supported on Support a (201124a)

Aqueous solution of Pd with a concentration of 0.02 g/g was prepared with palladium nitrate solution in advance, 13.2 g of the aqueous solution was taken and diluted with water to 200 g, then added with 19.7 g of support A and stirred overnight to make palladium fully adsorbed on the surface of the support, centrifuged for solid-liquid separation, and the solid matter was dried overnight at 120° C., taken out and cooled, subjected to soaking in 2 wt % diluted aqueous ammonia overnight, and centrifuged again, and the solid matter was dried at 120° C. overnight, then calcinated at 400° C. for 1 hour to obtain an exhaust purification catalyst of palladium supported on composite oxide support.

### Example 3: Catalyst of 0.924 wt % Palladium Supported on Support a (201105a)

Aqueous solution of Pd with a concentration of 0.02 g/g was prepared with palladium nitrate solution in advance, 9.24 g of the aqueous solution was taken and diluted with water to 200 g, then added with 19.8 g of support A and stirred overnight to make palladium fully adsorbed on the surface of the support, centrifuged for solid-liquid separation, and the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of palladium supported on support A.

### Example 4: Catalyst of 0.66 wt % Palladium Supported on Support a (200729c)

Aqueous solution of Pd with a concentration of 0.02 g/g was prepared with palladium nitrate solution in advance, 33.0 g of the aqueous solution was taken and diluted with water to 1000 g, then added with 99.3 g of support A and stirred overnight to make palladium fully adsorbed on the surface of the support, centrifuged for solid-liquid separation, and the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of palladium supported on support A.

### Example 4′: Catalyst of 0.66 wt % Palladium Supported on Support a (201212b)

Aqueous solution of Pd with a concentration of 0.02 g/g was prepared with palladium nitrate solution in advance, 6.60 g of the aqueous solution was taken and diluted with water to 50 g, then added with 19.9 g of support A and stirred overnight to make palladium fully adsorbed on the surface of the support, centrifuged for solid-liquid separation, the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of palladium supported on support A.

### Example 4″: Catalyst of 0.66 wt % Palladium Supported on Support a (201217b)

Aqueous solution of Pd with a concentration of 0.02 g/g was prepared with palladium nitrate solution in advance, 3.30 g of the aqueous solution was taken and diluted with water to 5.5 g, then added with 9.93 g of support A for equal-volume impregnation, and stood overnight, then dried overnight at 120° C., taken out and cooled, subjected to soaking in 2 wt % diluted aqueous ammonia overnight, and centrifuged, and the solid matter was dried at 120° C. for 8 hours, and then calcinated at 400° C. for 1 hour to obtain an exhaust purification catalyst of palladium supported on support A.

### Example 5: Catalyst of 0.396 wt % Palladium Supported on Support a (201124d)

Aqueous solution of Pd with a concentration of 0.02 g/g was prepared with palladium nitrate solution in advance, 3.96 g of the aqueous solution was taken and diluted with water to 200 g, then added with 19.9 g of support A and stirred overnight to make palladium fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of palladium supported on support A.

### Example 6: Catalyst of 0.397 wt % Palladium Supported on Support C (200820a)

Aqueous solution of Pd with a concentration of 0.01 g/g was prepared with palladium nitrate solution in advance, 0.795 g of the aqueous solution was taken and diluted with water to 20 g, then added with 2.0 g of support C and stirred overnight to make palladium fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of palladium supported on support C.

### Example 7: Catalyst of 0.147 wt % Silver Supported on Support C (200831d)

Aqueous solution of Ag with a concentration of 0.01 g/g was prepared with silver nitrate in advance, 1.59 g of the aqueous solution was taken and diluted with water to 20.0 g, then added with 1.98 g of support C and stirred overnight to make silver fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of silver supported on support.

### Example 8: Catalyst of 0.147 wt % Rhodium Supported on Support B (200729e)

Aqueous solution of Rh with a concentration of 0.02 g/g was prepared with rhodium nitrate solution in advance, 7.35 g of the aqueous solution was taken and diluted with water to 1000 g, then added with 99.8 g of support B and stirred overnight to make rhodium fully adsorbed on the surface of the support, centrifuged for solid-liquid separation, the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of rhodium supported on composite oxide support.

### Example 8′: Catalyst of 0.147 wt % Rhodium Supported on Support B (201212c)

Aqueous solution of Rh with a concentration of 0.02 g/g was prepared with rhodium nitrate solution in advance, 1.47 g of the aqueous solution was taken and diluted with water to 50.0 g, then added with 20.0 g of support B and stirred overnight to make rhodium fully adsorbed on the surface of the support, centrifuged for solid-liquid separation, the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of rhodium supported on composite oxide support.

### Example 8″: Catalyst of 0.147 wt % Rhodium Supported on Support B (201217c)

Aqueous solution of Rh with a concentration of 0.02 gig was prepared with rhodium nitrate solution in advance, 0.74 g of the aqueous solution was taken and diluted with water to 50 g, then added with 9.98 g of support B for equal-volume impregnation and stood overnight, then dried overnight at 120° C., taken out and cooled, subjected to soaking in 2 wt % diluted aqueous ammonia overnight, and centrifuged, and the solid matter was dried at 120° C. for 8 hours, and then calcinated at 400° C. for 1 hour to obtain an exhaust purification catalyst of rhodium supported on support B.

### Example 9: Catalyst of 0.103 wt % Rhodium Supported on Support B (201124i)

Aqueous solution of Rh with a concentration of 0.02 g/g was prepared with rhodium nitrate solution in advance, 1.03 g of the aqueous solution was taken and diluted with water to 200 g, then added with 20 g of support B and stirred overnight to make rhodium fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of rhodium supported on support B.

### Example 10: Catalyst of 0.074 wt % Rhodium Supported on Support B (201124j)

Aqueous solution of Rh with a concentration of 0.02 g/g was prepared with rhodium nitrate solution in advance, 0.735 g of the aqueous solution was taken and diluted with water to 200 g, then added with 20 g of support B and stirred overnight to make rhodium fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of rhodium supported on support B.

### Example 11: Catalyst of 0.795 wt % Palladium+0.132 wt % Rhodium Supported on Support C (200729a)

Aqueous solutions of Pd and Rh with a concentration of 0.02 gig were prepared respectively with palladium nitrate solution and rhodium nitrate solution in advance, 39.7 g of the aqueous solution of Pd and 6.62 g of the aqueous solution of Rh were taken respectively, and diluted with water to 1000 g, then added with 99.1 g of support C and stirred overnight to make palladium and rhodium fully adsorbed on the surface of the support, centrifuged for solid-liquid separation, the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of palladium-rhodium supported on support C.

### Example 11′: Catalyst of 0.795 wt % Palladium+0.132 wt % Rhodium Supported on Support C (201212a)

Aqueous solutions of Pd and Rh with a concentration of 0.02 g/g were prepared respectively with palladium nitrate solution and rhodium nitrate solution in advance, 7.95 g of the aqueous solution of Pd and 1.32 g of the aqueous solution of Rh were taken respectively, and diluted with water to 50 g, then added with 19.8 g of support C and stirred overnight to make palladium and rhodium fully adsorbed on the surface of the support, filtered by suction for solid-liquid separation, the solid matter was dried overnight at 120° C., taken out and cooled, subjected to soaking in 2 wt % diluted aqueous ammonia overnight, and filtered by suction again, and the solid matter was dried at 120° C. overnight, and then calcinated at 400° C. for 1 hour to obtain an exhaust purification catalyst of palladium-rhodium supported on support C.

### Example 11″: Catalyst of 0.795 wt % Palladium+0.132 wt % Rhodium Supported on Support C (201217a)

Aqueous solutions of Pd and Rh with a concentration of 0.02 g/g were prepared respectively with palladium nitrate solution and rhodium nitrate solution in advance, 3.97 g of the aqueous solution of Pd and 0.66 g of the aqueous solution of Rh were taken respectively, and diluted with water to 50 g, then added with 9.91 g of support C for equal-volume impregnation and stood overnight, then dried at 120° C. for 8 hours, taken out and cooled, subjected to soaking in 2 wt % diluted aqueous ammonia overnight, and centrifuged, and the solid matter was dried at 120° C. overnight, and then calcinated at 400° C. for 1 hour to obtain an exhaust purification catalyst of palladium-rhodium supported on support C.

### Example 12: Catalyst of 0.795 wt % Palladium+0.132 wt % Rhodium Supported on Support C (201202b)

Aqueous solutions of Pd and Rh with a concentration of 0.02 g/g were prepared respectively with palladium nitrate solution and rhodium nitrate solution in advance, 39.7 g of the aqueous solution of Pd and 6.62 g of the aqueous solution of Rh were taken respectively, and diluted with water to 1000 g, then added with 99.1 g of support C and stirred overnight to make palladium and rhodium fully adsorbed on the surface of the support, centrifuged for solid-liquid separation, the solid matter was dried overnight at 120° C., taken out and cooled, subjected to soaking in 2 wt % diluted ethylenediamine aqueous solution overnight, and centrifuged again, and the solid matter was dried at 120° C. overnight, and then calcinated at 400° C. for 1 hour to obtain an exhaust purification catalyst of palladium-rhodium supported on support C.

### Example 13: Catalyst of 0.397 wt % Palladium+0.795 wt % Silver Supported on Support C (200820d)

Aqueous solutions of Pd and Ag with a concentration of 0.01 g/g were prepared respectively with palladium nitrate solution and silver nitrate solution in advance, 0.795 g of the aqueous solution of Pd and 1.59 g of the aqueous solution of Ag were taken respectively, and diluted with water to 20 g, then added with 2.0 g of support C and stirred overnight to make palladium and silver fully adsorbed on the surface of the support, centrifuged for solid-liquid separation, the solid matter was dried overnight at 120° C., taken out and cooled, subjected to soaking in 2 wt % diluted aqueous ammonia overnight, and centrifuged again, and the solid matter was dried at 120° C. overnight, and then calcinated at 400° C. for 1 hour to obtain an exhaust purification catalyst of palladium-silver supported on support C.

### Example 14: Catalyst of 0.33 wt % Palladium+0.33 wt % Platinum Supported on Support A (200729d)

Aqueous solutions of Pd and Pt with a concentration of 0.02 g/g were prepared respectively with palladium nitrate solution and chloroplatinic acid in advance, 16.5 g of the aqueous solution of Pd and 16.5 g of the aqueous solution of Pt were taken respectively, and diluted with water to 1000 g, then added with 99.3 g of support A and stirred overnight to make palladium and platinum fully adsorbed on the surface of the support, centrifuged for solid-liquid separation, the solid matter was dried overnight at 120° C., taken out and cooled, subjected to soaking in 2 wt % diluted aqueous ammonia overnight, and filtered by suction, and the solid matter was dried at 120° C. overnight, and then calcinated at 400° C. for 1 hour to obtain an exhaust purification catalyst of palladium-platinum supported on support C.

### Comparative Example 1: Unsoaked Catalyst of 0.66 wt % Palladium Supported on Alumina (201204a)

Aqueous solution of Pd with a concentration of 0.02 g/g was prepared with palladium nitrate solution in advance, 3.96 g of the aqueous solution was taken and diluted with water to 120 g, then added with 11.9 g of support Al₂O₃ and stirred overnight to make palladium fully adsorbed on the surface of the support, centrifuged for solid-liquid separation, the solid matter was dried overnight at 120° C., taken out and cooled, and then calcinated at 400° C. for 1 hour to obtain an exhaust purification catalyst of palladium supported on support Al₂O₃.

### Comparative Example 2: Unsoaked Catalyst of 0.795 wt % Palladium+0.132 wt % Rhodium Supported on Support (201204a)

Aqueous solutions of Pd and Rh with a concentration of 0.02 g/g were prepared respectively with palladium nitrate solution and rhodium nitrate solution in advance, 39.7 g of the aqueous solution of Pd and 6.62 g of the aqueous solution of Rh were taken respectively, and diluted with water to 1000 g, then added with 99.1 g of support C and stirred overnight to make palladium and rhodium fully adsorbed on the surface of the support, centrifuged for solid-liquid separation, the solid matter was dried overnight at 120° C., taken out and cooled, and then calcinated at 400° C. for 1 hour to obtain an exhaust purification catalyst of palladium-rhodium supported on support C.

### Application Test Experiment:

(1) Comparative Test

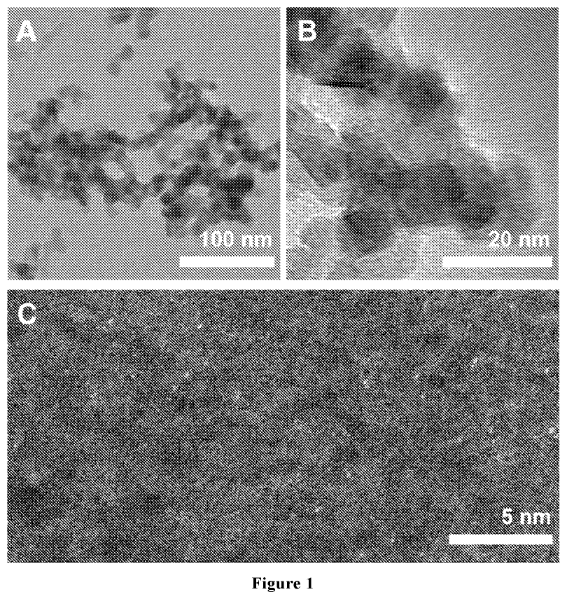

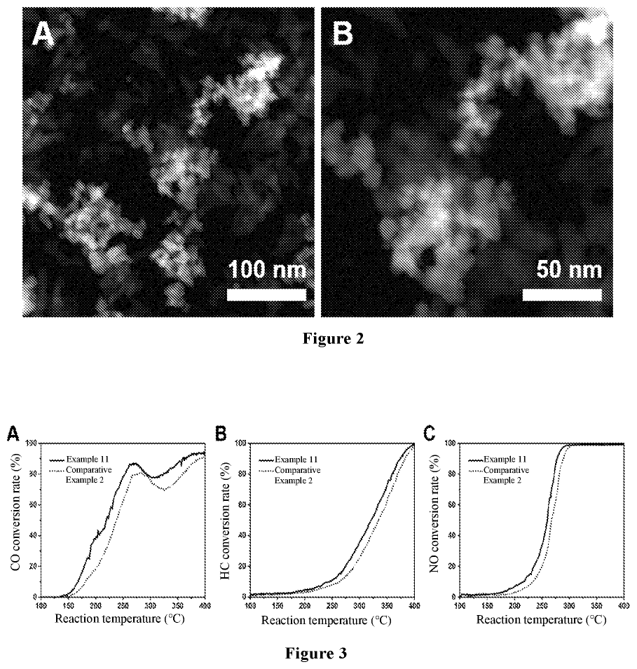

The microstructure analysis of the catalysts obtained in Example 11 and Comparative Example 2 was carried out respectively, and it is found that in the TEM and HR-TEM photographs of the catalyst of Example 11 which has been soaked in aqueous ammonia, no obvious metal nanoparticles are found within the detection range, and in the AC-STEM image, the active metal dispersed at the single-atomic level is visually observed (as shown in FIG. 1). In contrast, in the HR-TEM dark field photograph of Comparative Example 2, a large number of bright spots could be found, which are agglomerated noble metal; since the catalyst has not been reduced, the noble metal exists as amorphous oxide particles and does not have the lattice fringe at metallic state (as shown in FIG. 2).

According to the method of Preparation Example 2, the prepared catalyst samples and the samples of Comparative Examples 1-2 were tested, and the test results are shown in Table 1.

TABLE 1
Comparative test experiments and results

| | | T₅₀/° C. | | |
|---|---|---|---|---|
| Sample | Catalyst composition | CO | HC | NO |
| Example 1 (201008f) | Pd_{(0.66 wt %)}/Al₂O₃ | 296 | 342 | 311 |
| | (soaked with ammonia) | | | |
| Comparative Example 1 | Pd_{(0.660 wt %)}/Al₂O₃ | 310 | 348 | 321 |
| (201204a) | (unsoaked) | | | |
| Example 11 (200729a) | Pd_{(0.795 wt %)}Rh_{(0.132 wt %)}/support C | 219 | 321 | 260 |
| | (soaked with ammonia) | | | |
| Example 11′ (201212a) | Pd_{(0.795 wt %)}Rh_{(0.132 wt %)}/support C | 226 | 336 | 254 |
| | (soaked with ammonia) | | | |
| Example 11″ (201217a) | Pd_{(0.795 wt %)}Rh_{(0.132 wt %)}/support C | 226 | 340 | 257 |
| | (soaked with ammonia) | | | |
| Example 12 (201202b) | Pd_{(0.795 wt %)}Rh_{(0.132 wt %)}/support C | 228 | 334 | 257 |
| | (soaked with EDM) | | | |
| Comparative Example 2 | Pd_{(0.795 wt %)}Rh_{(0.132 wt %)}/support C | 238 | 334 | 268 |
| (201129a) | (unsoaked) | | | |

From the test results, after being soaked/washed with aqueous ammonia or ethylenediamine, no matter what kind of metal oxide support is used, the obtained catalysts show better test activity. Compared with the unwashed catalysts, the T₅₀ initial ignition temperature of the catalysts decreases significantly. Corresponding results could also be obtained from Figure X.

From the exhaust gas test analysis diagram in FIG. 3, it could also be concluded that the exhaust purification effect of catalyst of Example 11 is significantly improved compared with the catalyst of Comparative Example 2.

(2) Application Activity Test—Performance Test of Newly Prepared Catalysts

According to the method of Preparation Example 2, the prepared catalyst samples were tested, and the test results are shown in Table 2.

TABLE 2

| | | T₅₀/° C. | | |
|---|---|---|---|---|
| Sample | Catalyst composition | CO | HC | NO |
| Example 2 (201124a) | Pd_{(1.32 wt %)}/support A | 238 | 350 | 258 |
| Example 3 (201105a) | Pd_{(0.924 wt %)}/support A | 249 | 339 | 272 |
| Example 4 (200729c) | Pd_{(0.66 wt %)}/support A | 261 | 356 | 277 |
| Example 4′ (201212b) | Pd_{(0.66 wt %)}/support A | 265 | 370 | 265 |
| Example 4″ (201217b) | Pd_{(0.66 wt %)}/support A | 244 | 358 | 258 |
| Example 5 (201124d) | Pd_{(0.396 wt %)}/support A | 278 | — | 295 |
| Example 6 (200820a) | Pd_{(0.397 wt %)}/support C | 280 | 347 | 292 |
| Example 8 (200729e) | Rh_{(0.147 wt %)}/support B | 250 | 362 | 280 |
| Example 8′ (201212c) | Rh_{(0.147 wt %)}/support B | 246 | 362 | 268 |
| Example 8″ (201217c) | Rh_{(0.147 wt %)}/support B | 267 | 384 | 291 |
| Example 9 (201124i) | Rh_{(0.103 wt %)}/support B | 264 | — | 288 |
| Example 10 (201124j) | Rh_{(0.074 wt %)}/support B | 260 | 392 | 290 |
| Example 13 (200820d) | Pd_{(0.397 wt %)}Ag_{(0.795 wt %)}/support | 273 | 268 | 296 |
| | C | | | |
| Example 14 (200729d) | Pd_{(0.33 wt %)}Pt_{(0.33 wt %)}/support A | 300 | — | 324 |

* — indicates that no test result was obtained, because the maximum test temperature is 400° C., and when higher than 400° C., it is out of the measurement range.

(3) Application Activity Test—Catalyst Aging Test:

The catalysts of examples were placed in a porcelain boat, aged in air at 1000° C. for 10 hours in a muffle furnace, and their exhaust purification performance was tested. This experiment was used to simulate the activity of the catalysts after a long time of use, so as to understand the high temperature resistance and aging activity of the catalysts. This experiment could better reflect the catalytic performance of the catalysts under actual working conditions.

TABLE 3
Catalyst performance test after aging
(for catalysts after aging treatment)

| | | T₅₀/° C. | | |
|---|---|---|---|---|
| Sample | Catalyst composition | CO | HC | NO |
| Example 3 | Pd_{(0.924 wt %)}/support A | 292 | 292 | 292 |
| (201105a) | | | | |
| Example 4 | Pd_{(0.66 wt %)}/support A | 312 | 310 | 313 |
| (200729c) | | | | |
| Example 8 | Rh_{(0.147 wt %)}/support B | 269 | 271 | 279 |
| (200729e) | | | | |
| Example 11 | Pd_{(0.795 wt %)}Rh_{(0.133 wt %)}/support C | 242 | 241 | 246 |
| (200729a) | | | | |

The results of this test show good anti-high temperature activity. The aging test results of the examples of the present invention show that after 10 hours of aging, the initial ignition temperatures (T₅₀) of the three-way catalyst loaded with palladium and rhodium (Example 11) for the purification of three types of exhaust gases are all decreased to below 250° C. Compared with the mature products loaded with the same amount of noble metal on the market, the single-atomic three-way catalysts loaded with single metal show lower initial ignition temperatures (T₅₀) after 10 hours aging test, for example the initial ignition temperature for NO purification is decreased by at least 20° C., and the initial ignition temperature (T₅₀) for CO is decreased by more than 50° C. The catalyst with a noble metal loading decreased by 30% shows slightly lower or the same initial ignition temperature compared to the mature product on the market with 100% loading.

The above-mentioned examples of the present invention are only examples for clearly illustrating the present invention, rather than limiting the embodiments of the present invention. For those of ordinary skill in the art, on the basis of the above description, other variations or modifications of different forms can also be made, and not all embodiments are listed exhaustively, and all obvious changes or variations derived from the technical solutions of the present invention are still within the scope of protection of the present invention.

1. A preparation method of a noble metal single-atomic supported three-way catalyst, comprising:
Step A: loading a noble metal precursor in a designed load amount on an oxide support to form a noble metal single-atomic catalyst precursor;
Step B: using a nitrogen-containing compound to treat the noble metal single-atomic catalyst precursor;
Step C: calcining the noble metal single-atomic catalyst precursor treated with the nitrogen-containing compound as obtained in Step B, to obtain the noble metal single-atomic supported three-way catalyst;
the noble metal precursor is a soluble noble metal inorganic salt, or a noble metal organic salt, or a noble metal complex; alternatively, the noble metal precursor is nitrate, chloride, sulfate, acetate, acetylacetonate or chlorine complex; and the soluble means soluble in water or alcohol, wherein the alcohol is methanol or ethanol;
in the noble metal single-atomic supported three-way catalyst, the noble metal is dispersed in the state of single-atomic sites on the oxide support, wherein the noble metal is one, or a combination of two or more of platinum, palladium, rhodium, ruthenium, iridium, osmium, gold and silver;
the oxide support is alumina, silica-alumina, ceria-zirconia mixed oxide, or molecular sieve, or a mixture of any two or more thereof, and optionally doped with BaO, La₂O₃ and/or Y₂O₃; or the oxide support is a mixed oxide of Al₂O₃ and Zr—Ce-M-Oₓ oxide, wherein M is one or more selected from the group consisting of Ba, Sr, La, Y, Pr, Nd;
the nitrogen-containing compound is NH₃, dimethylformamide, urea, C₁₋₂₀ alkane amine, C₂₋₂₀ alkene amine, C₁₋₂₀ alkane diamine, C₁₋₂₀ alkane triamine, or C₆₋₂₀ aromatic amine; alternatively, the nitrogen-containing compound is NH₃, dimethylformamide, urea, C₁₋₆ alkane amine, C₁₋₆ alkane diamine, or C₆₋₂₀ aromatic amine; alternatively NH₃, ethylenediamine, triethylamine, n-butylamine or dimethylformamide; optionally an aqueous or alcoholic solution of the nitrogen-containing compound can be used, wherein the alcoholic solution is a methanol or ethanol solution.

2. The preparation method according to claim 1, wherein, in the step A, mixing the oxide support with a noble metal salt solution, and separating the mixture to obtain a noble metal supported catalyst precursor; in the step B, using a nitrogen-containing compound to soak or wash the noble metal single-atomic catalyst precursor, and then undergoing solid-liquid separation to obtain a solid catalyst precursor; before the step C, drying the solid catalyst precursor as required; and in the step C, calcining at 200-600° C., or at 300-500° C.

3. The preparation method according to claim 1, wherein the noble metal salt is a nitrate, chloride, acetate, acetylacetonate or chlorine complex of noble metal; the noble metal is platinum, rhodium, palladium or iridium, or a combination of two or more thereof, the content of the noble metal is 0.01-5 wt %, or 0.05-2 wt %, based on the weight of the catalyst.

4. The preparation method according to claim 1, wherein the oxide support is a mixed oxide of Al₂O₃ and Zr—Ce-M-Oₓ oxide, in this mixed oxide, where a the content of Al₂O₃ is 15-80 wt %, the content of Zr—Ce-M-Oₓ is 20-85 wt %; the nitrogen-containing compound is an aqueous ammonia with a concentration of 0.5-15 wt %, or an aqueous solution of ethylenediamine with a concentration of 0.5-15 wt %, alternatively an aqueous ammonia or an aqueous solution of ethylenediamine with a concentration of 0.5-5 wt %.

5. A method for preparing a noble metal single-atomic three-way catalyst, comprising:
Step 1: using a nitrogen-containing compound to treat a noble metal single-atomic catalyst precursor;
Step 2: calcining the noble metal single-atomic catalyst precursor treated with the nitrogen-containing compound to obtain the noble metal single-atomic three-way catalyst;
in the noble metal single-atomic catalyst precursor, the noble metal is dispersed in the state of single-atomic sites on a support; the noble metal is selected from the group consisting of platinum, palladium, rhodium, ruthenium, iridium, osmium, gold, silver, and the noble metal is a single one thereof, or a combination of two thereof, or combination of more thereof;
the support is alumina, silica-alumina, ceria-zirconia mixed oxide, or molecular sieve or a mixture of any two or more thereof, and optionally doped with BaO, La₂O₃, Y₂O; or the support is a mixed oxide of Al₂O₃ and Zr—Ce-M-Oₓ oxide, wherein M is one or more selected from the group consisting of Ba, Sr, La, Y, Pr, Nd, and in the mixed oxide, the content of Al₂O₃ is 15-80 wt %, and the content of Zr—Ce-M-Oₓ is 20-85 wt %;
the nitrogen-containing compound is NH₃, dimethylformamide, urea, C₁₋₂₀ alkane amine, C₂₋₂₀ alkene amine, C₁₋₂₀ alkane diamine, C₁₋₂₀ alkane triamine or C₆₋₂₀ aromatic amine alternatively, the nitrogen-containing compound is NH₃, dimethylformamide, urea, C₁₋₆ alkane amine, C₁₋₆ alkane diamine or C₆₋₂₀ aromatic amine; alternatively, the nitrogen-containing compound is NH₃, ethylenediamine, triethylamine, n-butylamine or dimethylformamide; optionally, an aqueous or alcoholic solution of the nitrogen-containing compound can be used, wherein the alcoholic solution is a methanol or ethanol solution.

6. The method according to claim 5, wherein in the step 1, using the nitrogen-containing compound to soak or wash the noble metal single-atomic catalyst precursor, then undergoing solid-liquid separation to obtain the noble metal single-atomic catalyst precursor treated with the nitrogen-containing compound; before the step 2, drying the noble metal single-atomic catalyst precursor treated with the nitrogen-containing compound as required; and in the step 2, calcining at 200-600° C., or at 300-500° C.

7. The method according to claim 5, wherein the content of the noble metal is 0.01%-5%, or 0.05-2%, based on the weight of the catalyst; the support is a mixed oxide of Al₂O₃ and Zr—Ce-M-Oₓ oxide, wherein M is one or more selected from the group consisting of Ba, Sr, La, Y, Pr, Nd, in the mixed oxide, the content of Al₂O₃ is 15-80 wt %, and the content of Zr—Ce-M-Oₓ is 20-85 wt %.

8. The method according to claim 5, wherein the nitrogen-containing compound is an aqueous ammonia with a concentration of 0.5-15 wt %, or an aqueous solution of ethylenediamine with a concentration of 0.5-15 wt %, alternatively an aqueous ammonia with a concentration of 0.5-5 wt % or an aqueous solution of ethylenediamine with a concentration of 0.5-5 wt %.

9. A method for purifying motor vehicle exhaust, comprising using the noble metal single-atomic three-way catalyst prepared by the method according claim 1 to purify a motor vehicle exhaust, wherein the catalyst is used alone or used by coating it on a honeycomb carrier for purifying the motor vehicle exhaust; wherein the honeycomb carrier is an alloy honeycomb carrier and/or a ceramic honeycomb carrier.

10. A noble metal single-atomic three-way catalyst, wherein the is prepared by the method according to claim 1, the noble metal is platinum, rhodium, palladium, or iridium or a combination of two or more thereof, the content of the noble metal is 0.01-5 wt %, or 0.05-2 wt % based on the weight of the catalyst; the oxide support is a mixed oxide of Al₂O₃ and Zr—Ce-M-Oₓ oxide, wherein M is one or more selected from the group consisting of Ba, Sr, La, Y, Pr, Nd, in the mixed oxide, the content of Al₂O₃ is 15-80 wt %, the content of Zr—Ce-M-Oₓ is 20-85 wt %, wherein, the noble metal is dispersed in the state of single-atomic sites on the oxide support.

11. A method for purifying motor vehicle exhaust, comprising using the noble metal single-atomic three-way catalyst prepared by the method according to claim 5 to purifying a motor vehicle exhaust, wherein the catalyst is used alone or used by coating it on a honeycomb carrier for purifying the motor vehicle exhaust; the honeycomb carrier is an alloy honeycomb carrier and/or a ceramic honeycomb carrier.

12. A noble metal single-atomic supported three-way catalyst by the method according to claim 5, the noble metal is platinum, rhodium, palladium, or iridium or a combination of two or more thereof, the content of the noble metal is 0.01-5 wt %, or 0.05-2 wt % based on the weight of the catalyst; the support is a mixed oxide of Al₂O₃ and Zr—Ce-M-Oₓ oxide, wherein M is one or more selected from the group consisting of Ba, Sr, La, Y, Pr, Nd, in the mixed oxide, the content of Al₂O₃ is 15-80 wt %, the content of Zr—Ce-M-Oₓ is 20-85 wt %, wherein, the noble metal is dispersed in the state of single-atomic sites on the oxide support.
